(19) United States
(12) Patent Application Publication
(10) Pub. No.: US 2018/0370497 A1
(43) Pub. Date: Dec. 27, 2018

(54) DEVICE FOR CONDUCTING A FLUID TO A WIPER ARM OF AN AUTOMOBILE, WIPER ARM, AND WIPER ARM UNIT OF AN AUTOMOBILE, WHICH IN PARTICULAR HAVE SUCH A DEVICE, AND A METHOD FOR PRODUCING A DEVICE FOR CONDUCTING A FLUID TO A WIPER ARM OF AN AUTOMOBILE

(71) Applicant: A. Raymond et Cie., Grenoble (FR)

(72) Inventors: Stephan Häfner, Prebitz (DE); Karl Bode, Lörrach (DE); Axel Feger, Lörrach (DE)

(73) Assignee: A. Raymond et Cie., Grenoble (FR)

(21) Appl. No.: 15/780,975

(22) PCT Filed: Nov. 29, 2016
(86) PCT No.: PCT/EP2016/002012

§ 371 Date: Jun. 1, 2018

(30) Foreign Application Priority Data
Dec. 3, 2015 (DE) 10 2015 015 553.9

(51) Int. Cl. B60S 1/48; B60S 1/52

(52) U.S. Cl. CPC B60S 1/488; B60S 1/522

(57) ABSTRACT

The invention relates to a device for guiding a fluid on a wiper arm of an automobile, wherein the device encompasses at least one channel and a heating wire, wherein a heating wire extending along the channels is arranged on two channels.

In order to improve the cleaning result of a wiper arm on a vehicle window, water can be sprayed onto the window, for example by a washing nozzle situated on the engine hood or a nozzle on the wiper. Arranging the nozzle on the wiper arm or wiper can be advantageous for spraying fluid, for example water, onto the window directly in front of the wiper in the direction of movement of the wiper.

Known from DE 20 2005 016 941 U1 is a windshield wiper for vehicle windows, in which the leg of a U forming a base body of the windshield wiper is provided for each direction of movement. Each leg of the base body is arranged essentially perpendicular to the direction of movement of the windshield wiper, and one of the two legs forms the front leg, and the other leg the rear leg, during the movement. Each of the legs accommodates an external water channel for cleaning water, from which the cleaning liquid is dispensed in several water outlet gaps with a small gap width or water outlet holes. Provided on either side of each water hole are a respective two channels for a heating wire, so as to guide a heating wire along the longitudinal extension of the windshield wiper and back again. Further provided are additional water channels and water outlet holes or water outlet gaps allocated thereto, wherein two channels for heating wires are provided on either side of each water outlet hole. Configuring the windshield wiper for spraying the window in an operating direction before the windshield wiper is complicated, since two channels for a heating wire must be fabricated for each water channel.

Therefore, the object of the invention is to provide a device for guiding a fluid on a wiper arm of an automobile, which can be more easily assembled and/or fabricated, and yet in particular largely prevent the fluid from freezing.

This object is achieved by the subject matter of the independent claims. Advantageous embodiments are indicated in the subclaims and following specification.

The invention proceeds from the basic idea of being able to fabricate a device for guiding a fluid on a wiper arm of an automobile, in which a heating wire is provided for more than one channel, i.e., two or more channels, along which the at least one heating wire can extend. To this end, a heating wire extending along the channels is situated on two channels in the device. One and the same heating wire can be situated in the channels. As a result, heating a liquid located in the channels can be simplified, since several channels can be heated by one heating wire. Providing a single heating wire makes it possible to simplify an electrical connection with a voltage source, which can supply voltage to the heating wire. Device manufacture is simplified, since a lower number of heating wires, in particular only one, can be used.

According to the invention, the term “fluid” encompasses a liquid, in particular an aqueous liquid. In particular, the liquid can be an aqueous liquid with an antifreeze and/or cleaning agent.

According to the invention, the term “channel” encompasses a line for conveying or guiding a fluid. The term “channel” also encompasses a partial section of a line. The term “channel” also encompasses a channel line, i.e., a channel provided with at least one coupling, for example a plug-like or bushing-like element. The channel can be flexible or rigid in design. It is possible for the channel to have rigid sections and flexible sections. In particular, a channel in the sense of the invention can be connected with a device for pressurizing the fluid. A channel can exhibit an inlet for pressurized fluid. In a preferred embodiment, at least sections of the channel can be opened along its length. The inner wall of a channel can exhibit several, preferably two sections, which can be joined together. A channel can be designed as a hollow space in an elongated body, in particular a section of a wiper arm. The body can exhibit several, in particular two, connectable body sections, which envelop a channel. Access can preferably be made to the interior of the two channels simultaneously when a body section is separated from another body section; a heating wire can be placed in the two channels. A body section can be shaped like a cover-like body section, and a body section can be designed as a body section that essentially accommodates the channel. A channel can also take the form of a tube.

A numerical value encompasses the exact number of the number indicated by the numerical value, as well as a number greater than the number indicated by the numerical value. In addition to exactly one element that is specified by the substantive following the article, the indeterminate article can also encompass more than one element, i.e., two, three, four or more elements.

The term “heating wire” encompasses a heating resistor designed like a wire, which converts electrical energy into thermal energy. The heat is generated by having a current flow through the heating resistor, thereby heating it up. In a preferred embodiment, the heating resistor is a conductive material with a high electrical resistance. The heating wire can exhibit a jacket, which can be electrically insulating in design.

According to the invention, the preposition “on” for geometrically describing the arrangement of a heating wire “on” two channels encompasses (a) arranging the heating wire around the outside of the channels or along the outside of the channels, (b) arranging the heating wire in an inner wall of the channels or a jacket of the channels, and (c) arranging the heating wire inside the two channels, so that the heating wire can be situated in the fluid.

According to the invention, the preposition “on” for specifying the arrangement of the device “on” the wiper arm encompasses (a) arranging the device adjacent to the wiper arm, (b) integrating the device into the wiper arm, and (c) an identity of the device that can form the wiper arm.

In the sense of the invention, the term “automobile” encompasses a multi-track motor vehicle, in particular a road vehicle driven by an engine. The term “motor vehicle” or “automobile” also encompasses an electric car.

In the sense of the invention, the term “wiper” encompasses in particular windshield wipers. A windshield wiper can be designed in particular for wiping a windshield, or rear window. In the sense of the invention, the term “wiper” also encompasses a wiper for an in particular translucent cover element of an automobile lamp, in particular an automobile headlamp. The term “wiper arm” encompasses the moving section of the wiper, which sweeps over the cover element at least partially during the movement.

The two channels preferably exhibit two spaced apart openings for the fluid to pass through, so that the fluid from the channel can exit the channel into the outside environment. The opening can be joined with the channel by means of an additional channel section, which is not provided with any heating wire. In this case, each channel can have allocated to it an opening for the fluid to pass through. The heating wire can extend between the two openings allocated to the channels.

In particular, the heating wire can extend between the channel of one opening and the other channel of the other opening. As a result, fluid can be carried toward the outside from each channel, wherein the fluid can pass from the device at locations spaced apart from each other, without having to deviate from providing just a single heating wire for the several channels. For example, it can be provided that a pressurized fluid be supplied to only one of the two channels, depending on the direction of movement of the wiper arm. The heating wire can be guided between the two channels on an intermediate piece, which does not have to carry any fluid. Aside from the two channels on which the heating wire is arranged, another channel section can be provided on the device between a channel and an opening, as can an intermediate piece between the two channels. The heating wire can be guided on the channels and intermediate piece, wherein the channels can be fluidically sealed relative to the intermediate piece.

The channels, possibly along with the intermediate piece, preferably exhibit a ring segment shaped progression, so that a curved progression of the guided fluid can be achieved via the channels. In particular, the two channels can include an angle with each other that exceeds 90°, preferably exceeds 130°, especially preferably exceeds 170°. As a result, the channels can run next to each other in a section, preferably essentially parallel to each other. Such an arrangement economizes on space.

The heating wire is preferably designed as a single piece, so that a simple electrical element can be used, for example, which can be adjusted to the shape of the two channels, for example via bending.

In a preferred embodiment, the heating wire is situated in the channels, so that the heating wire is arranged in the lumen provided for the fluid. As a result, the heating wire can come into direct contact with the fluid, so that the fluid can be directly heated by the heating wire. Arranging the heating wire in the channel, i.e., in the lumen defined by the channel, further makes it possible to omit a special arranging step or manufacturing step that embeds the heating wire into the wall of the channel or arranges the heating wire around the channel. The heating wire can be placed in one or more channels that are openable in the longitudinal direction in one procedural step.

In a preferred embodiment, the heating wire is fixed in place by means of a spacer element. In particular, the spacer element can be situated on the channel boundary. The spacer element can be used to set a defined progression of the heating wire. The spacer element can fix the heating wire in place both in relation to the cross section of the channel and in relation to the length of the channel.

The spacer element preferably at least partially forms a closure of a channel, so that an element permits both a fixation and closure of the channel, wherein two channels can preferably be closed with one spacer element, so that the number of required elements can be further reduced. A sealing element can be provided in addition to or integrally with the spacer element, for example in the form of a passage for the stopper exhibiting the heating wire, in particular made out of silicone.

In a preferred embodiment, the spacer element is situated in the area of at least one opening for the fluid to pass through, so that the heating wire can be definably fixed in particular in the area in which the fluid can exit from a channel. The spacer element can also be provided centrally between the channels.

In a preferred embodiment, the spacer element is thermally conductive. As a result, in particular an intermediate piece adjoining the spacer element or formed in the spacer element can incorporate a heat pipe that warms the area around the spacer element or the area of the spacer element without having to provide a heating wire in the area.

In a preferred embodiment, the spacer element can exhibit a cast-in plastic. The spacer element can be formed by casting a plastic into an area of a channel or intermediate piece and hardening it. Additionally or alternatively, it can also be provided that the spacer element exhibit two or more connectable elements, of which at least one encompasses a guiding element for the heating wire. For example, the elements can be two plate-shaped elements, which can be joined together by means of a plug connection. The plate-shaped elements can also be pressed one onto the other. The plate-shaped elements can also be adhesively bonded. A guiding element can be formed on at least one of the connectable elements. The guiding element can be designed as a groove, into which the heating wire is placed, and thus can be fixed in the groove. While the groove is formed in one of the elements, a cover that closes the groove with the heating wire can be provided in the other element.

The invention also provides a wiper arm of an automobile, which exhibits a device described above.

The device also provides a wiper arm unit of an automobile encompassing a device described above and a wiper blade. The wiper arm unit can exhibit a pump and/or a fluid tank.

The invention further provides a method for manufacturing a device for guiding a fluid on a wiper arm of an automobile, in which a heating wire is situated on two channels for supplying the fluid. As a result, a single heating wire that is able to extend through two or more channels can be used to heat the fluid during manufacture.

The invention will be explained below based on exemplary embodiments shown on the drawings.

Shown on:

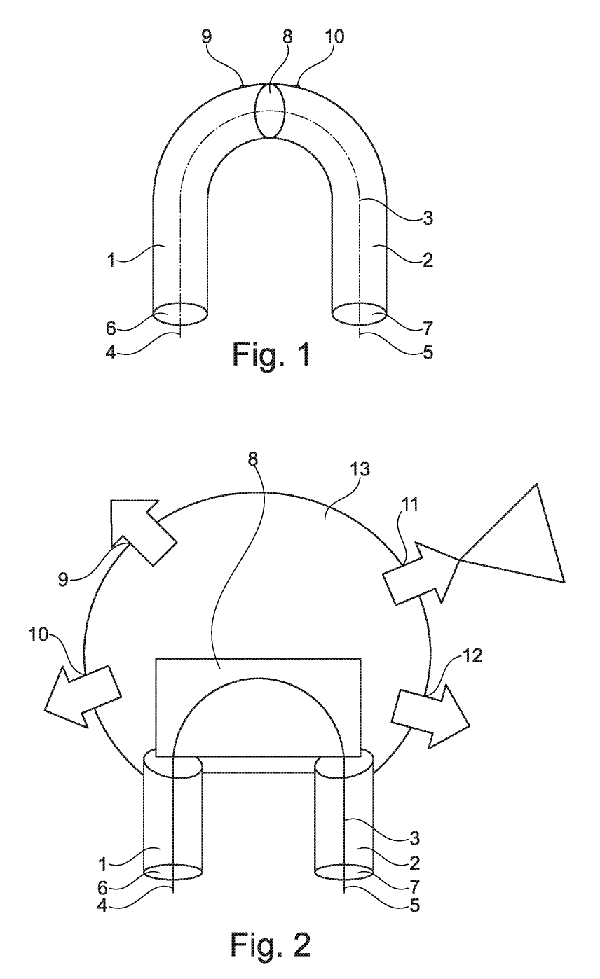

FIG. 1 is a first exemplary embodiment of the invention;

FIG. 2 is a second exemplary embodiment of the invention;

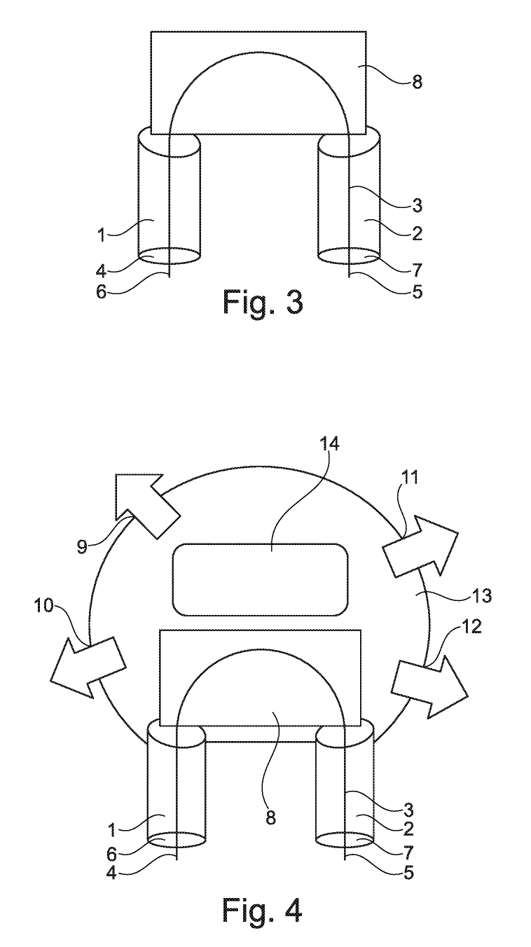

FIG. 3 is a third exemplary embodiment of the invention;

FIG. 4 is a fourth exemplary embodiment of the invention;

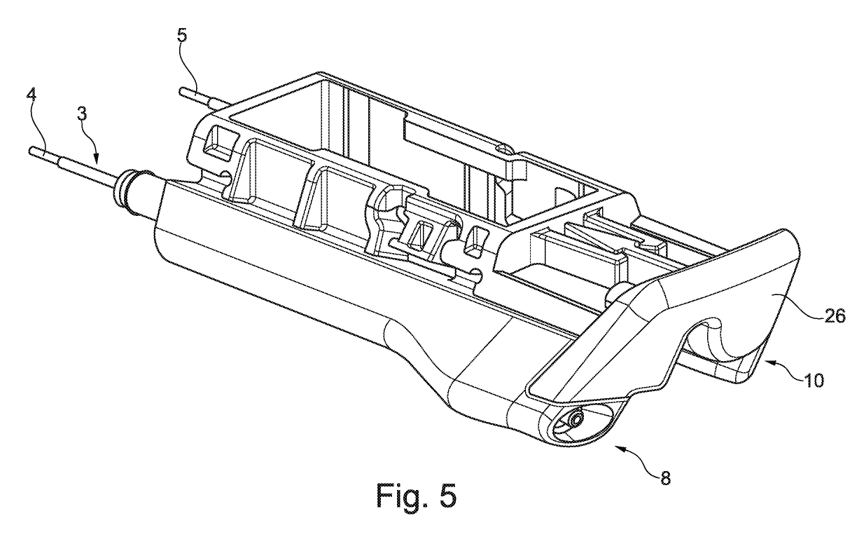

FIG. 5 is a partial area of a fifth exemplary embodiment of the invention in an inclined, frontal isometric view;

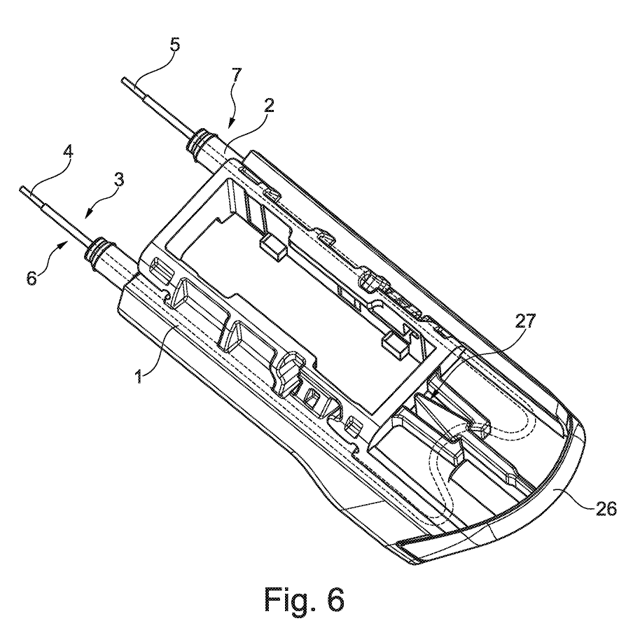

FIG. 6 is a partial sectional view of the exemplary embodiment on FIG. 5 as viewed at an inclination from above;

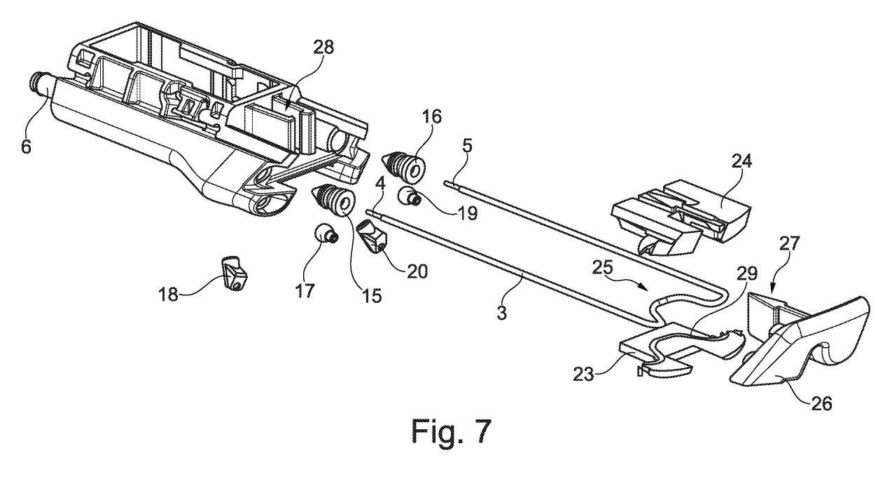

FIG. 7 is an exploded view of the exemplary embodiment on FIG. 5;

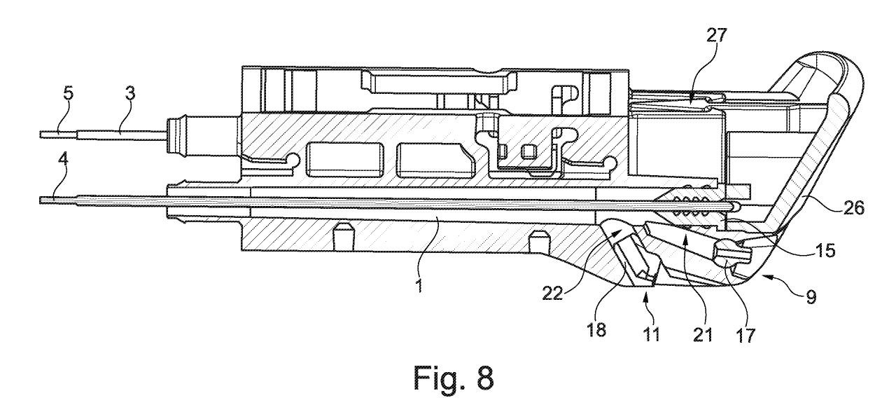

FIG. 8 is a partial sectional view from the side of the exemplary embodiment on FIG. 5; and

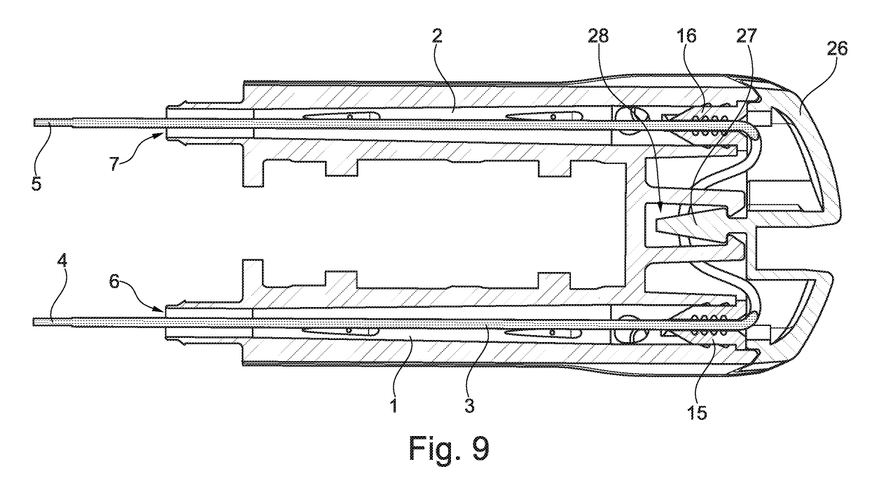

FIG. 9 is a partial sectional view from above of the exemplary embodiment on FIG. 5.

FIG. 1 presents a schematic illustration of a device for guiding a fluid on a wiper arm of an automobile. The device exhibits two channels 1, 2, through which a heating wire 3 extends. The ends 4, 5 of the heating wire 3 can be contacted with a voltage source and exposed to a voltage. At the ends 6, 7 of the channels 1, 2, the channels 1, 2 can be supplied with a fluid, which can be pressurized. Situated between the channels 1, 2 is a spacer element 8, which separates the channels 1, 2, and, on their end sides, spaced apart from the ends 6, 7, essentially closes them off from the fluid, and fixes the heating wire 3 in place. Openings 9, 10 are formed in the area of the spacer element 8, and configured for the fluid to pass through as it exits the respective channel 1, 2 into the environment. The openings 9, 10 for the fluid to pass through can exhibit nozzles.

The heating wire 3 is designed as a single piece, and extends over the two channels 1, 2. The channels 1, 2 can be impinged solely with a fluid simultaneously or alternatingly, so that fluid exits the device into the environment only at one of the two openings 9, 10 or at both of the two openings 9, 10.

In the embodiment shown on FIG. 1, the channels 1, 2 are formed by introducing the heating wire 3 with the spacer element 8 into a tube and aligning it therein. The tube was bent and given the shape depicted on FIG. 1.

FIG. 2 shows another embodiment of a device for guiding a fluid to a wiper arm of an automobile. The end side of the channels 1, 2 empties into an opening array 13, which exhibits several openings 9, 10, 11, 12 for the fluid to pass through. The opening array 13 incorporates a spacer element 8, on which the heating wire 3 is guided. In the exemplary embodiment depicted on FIG. 2, it is predetermined that the heating wire 3 lies in a trough, following its geometry. A defined spray pattern can be achieved by means of the openings 9, 10, 11, 12, which can exhibit nozzles.

FIG. 3 shows a schematic view of another embodiment that provides a spacer element 8, which guides the heating wire 3 between the two channels 1, 2. In the area of the ends of the two channels 1, 2, a defined position of the two channels 1, 2 relative to each other can be achieved by means of the spacer element 8. In the embodiment depicted on FIG. 3, the spacer element can take the form of a casting compound, or is present as a multipart spacer element 8, which exhibits spacer element sections that can be joined together. The spacer element sections can be detachably or non-detachably connected. The heating wire 3 can be clamped between the spacer element sections.

FIG. 4 shows a schematic view of another embodiment of the device for guiding a fluid on a wiper arm of the automobile, in which another heating element 14 is provided in addition to the heating wire 3.

FIGS. 5 to 9 present views of a partial area of an exemplary embodiment of the invention as part of a wiper arm. The same reference numbers as for the exemplary embodiments described above are used, so long as the referenced elements are identical.

FIG. 5 is an isometric view at an inclination from the front. Formed on the wiper arm are openings 9, 10, which are designed for a fluid guided in the wiper arm to pass through into the open. The openings 9, 10 for the fluid to pass through can exhibit nozzles (see FIGS. 7 and 8). FIG. 5 depict the ends 4, 5 of a heating wire 3 guided in the wiper arm. In the exemplary embodiment shown on FIG. 5, the heating wire 3 is provided as a heating wire 3 insulated with a jacket, in which the ends 4, 5, which can be contacted with a voltage source and exposed to a voltage, are exposed, and the electrical conductor of the heating wire 3 is unsheathed and bare. As shown among other places on FIG. 6, the heating wire 3 extends as a single piece from end 4 to end 5 through a channel 1 and another channel 2 of the wiper arm. Opening 9 is allocated to channel 1, and opening 10 is allocated to channel 2. The channels 1, 2 can be supplied at the ends 6, 7 of the channels 1, 2 with a fluid, which can be pressurized and exit the openings 9, 10. The heating wire 3 can heat the fluid both in channel 1 and in channel 2. The heating wire 3 exhibits an essentially preformed, stable shape.

As evident from FIG. 7, which presents an exploded view of the exemplary embodiment shown on FIGS. 5 to 9, the preformed heating wire 3 can be placed into the wiper arm in such a way that the heating wire 3 can be inserted into an end of the wiper arm lying opposite the end of the wiper arm that exhibits the ends 6, 7 of the channels 1, 2. The channels 1, 2 are circumferentially closed in the longitudinal direction, and only their ends are bare.

The heating wire 3 exhibits an essentially U-shaped form with two elongated legs. A respective leg extends at least partially in one of the channels 1, 2. The heating wire 3 exhibits a bend in the area of the base, which is bent in the direction of the legs. The heating wire 3 exhibits a mirror symmetry relative to the middle of the base of the U. The ends 4, 5 of the heating wire 3 can be used to insert it into the channels 1, 2, and guide it through the latter.

The channels 1, 2 can be sealed on the end side at one end of the channel 1, 2 by means of a gasket 15, 16, through which the heating wire 3 can pass. The gaskets 15, 16 can be designed in such a way that the fluid does not wash around the heating wire 3 in the area of the base of the essentially U-shaped progression. Nozzles 17, 18 are provided for the openings 9, 11, while nozzles 19, 20 are correspondingly provided for the channel 2 or allocated openings 10, 12.

As evident from FIG. 8, the fluid present in the channel 1 can be heated by means of the heating wire that runs essentially in the middle of the channel 1. Channel sections 21, 22 extend from the channel 1 to the openings 9, 11.

Provided to fix the heating wire 3 in the wiper arm are two guiding elements 23, 24, which can accommodate the heating wire 3 between them, in particular in the area of the base 25 of the heating wire 3. To this end, a partial profile configured as a partial groove 29 (only a lower area of the heating wire 3 is enclosed) is formed both in the guiding element 23 and in the guiding element 24, and follows the progression of the preformed heating wire 3. A partial groove is also formed in the upper guiding element 24, and circumferentially envelops the upper area of the heating wire 3. In an assembled form, the guiding elements 23, 24 yield a channel for the heating wire 3 in the area of the base 25, as a result of which the heating wire 3 is fixed in place by the guiding elements 23, 24.

The guiding elements 23, 24 can be made to abut against corresponding contours in the wiper arm. In an assembled form, the heating wire 3 and guiding elements 23, 24 are inserted into the wiper arm, and aligned based on the abutting sections, which correspond with abutting sections of the guiding elements 23, 24. The guiding elements 23, 24 are fixed in place for the heating wire 3 on the wiper arm via a cap-shaped element 26, which can be designed as an end-side closing element of the wiper arm, which at least partially yields a closure for the wiper arm. In particular in order to fix the guiding elements 23, 24 in the wiper arm, the cap-shaped element 26 exhibits an arrow-shaped plug element 27, which can be inserted into a corresponding opening of a receptacle 28, so as to positively fix the guiding elements 23, 24 for the heating wire 3 on the wiper arm.

1. A device for guiding a fluid on a wiper arm of an automobile, wherein the device encompasses at least one channel and a heating wire, characterized in that a heating wire extending along the channels is arranged on two channels.

2. The device according to claim 1, characterized in that the two channels have allocated to them two spaced apart openings for the fluid to pass through, and the heating wire extends between the two channels.

3. The device according to claim 2, characterized in that a nozzle is formed at least on one opening.

4. The device according to claim 1, characterized in that the channels exhibit a ring segment shaped progression and/or run essentially parallel to each other.

5. The device according to claim 1, characterized in that the heating wire is designed as a single piece.

6. The device according to claim 1, characterized in that the heating wire is at least partially situated in the channels.

7. The device according to claim 1, characterized in that the heating wire is fixed in place by means of a spacer element.

8. The device according to claim 7, characterized in that the spacer element comprises a closure of the channel for the fluid.

9. The device according to claim 7, characterized in that the spacer element is situated in the area of at least one opening for the fluid to pass through.

10. The device according to claim 7, characterized in that the spacer element is thermally conductive.

11. The device according to claim 7, characterized in that the spacer element exhibits a cast-in plastic and/or a guiding element, which encompasses two connectable elements.

12. A wiper arm of an automobile exhibiting a device according to claim 1.

13. A wiper arm unit of an automobile exhibiting a device according to claim 1 and a wiper blade.

14. A method for manufacturing a device for guiding a fluid to a wiper arm of an automobile, in particular according to claim 1, in which a heating wire is situated on two channels for supplying the fluid.

15. The device according to claim 2, characterized in that the channels exhibit a ring segment shaped progression and/or run essentially parallel to each other.

16. The device according to claim 2, characterized in that the heating wire is designed as a single piece.

17. The device according to claim 2, characterized in that the heating wire is at least partially situated in the channels.

18. A wiper arm of an automobile exhibiting a device according to claim 2.

19. A wiper arm unit of an automobile exhibiting a device according to claim 2 and a wiper blade.

20. A method for manufacturing a device for guiding a fluid to a wiper arm of an automobile, in particular according to claim 2, in which a heating wire is situated on two channels for supplying the fluid.
